(19) United States
(12) Patent Application Publication
(10) Pub. No.: US 2024/0024983 A1
(43) Pub. Date: Jan. 25, 2024

(54) METHOD FOR LASER WELDING BENT, ALUMINUM-CONTAINING BAR-TYPE CONDUCTORS, IN PARTICULAR FOR AN ELECTRIC MOTOR

(71) Applicant: TRUMPF Laser- und Systemtechnik GmbH, Ditzingen (DE)

(72) Inventors: Oliver Bocksrocker, Sachsenheim (DE); Nicolai Speker, Pleidelsheim (DE); Tim Hesse, Ditzingen (DE); Matthias Beranek, Stuttgart (DE)

(21) Appl. No.: 18/482,039

(22) Filed: Oct. 6, 2023

Related U.S. Application Data
(63) Continuation of application No. PCT/EP2022/059224, filed on Apr. 7, 2022.

(30) Foreign Application Priority Data
Apr. 16, 2021 (DE) 10 2021 109 623.5

(51) Int. Cl. B23K 26/26

(52) U.S. Cl. CPC B23K 26/26

(57) ABSTRACT

A method for laser welding includes arranging two bar-type conductors next to one another with a partial overlap, and welding the two bar-type conductors to one another using a processing laser beam. A weld bead is formed on a common base surface of the bar-type conductors. During the welding, the processing laser beam is guided so that a welding contour is placed relative to the bar-type conductors. An advancing rate of the processing laser beam along the welding contour is selected such that the weld bead has a non-liquid oxide skin inside which liquid bar-type conductor material accumulates. The non-liquid oxide skin is partially broken open by the processing laser beam only on an upwardly facing end face of the weld bead, and remains undamaged in a surrounding region of the weld bead that extends downward from the upwardly facing end face and around the entire weld bead.

### CROSS REFERENCE TO RELATED APPLICATIONS

This application is a continuation of International Application No. PCT/EP2022/059224 (WO 2022/218804 A2 and WO 2022/218804 A3), filed on Apr. 7, 2022, and claims benefit to German Patent Application No. DE 102021109623.5, filed on Apr. 16, 2021. The aforementioned applications are hereby incorporated by reference herein.

### FIELD

Embodiments of the present invention relate to a method for laser welding bar-type conductors.

### BACKGROUND

A method has been disclosed by the online publication “STATOR HAIRPINS AUS ALUMINIUM ENTLACKEN UND SCHWEISSEN—GROSSES EINSPARPOTENZIAL” (“Stripping and welding stator hairpins of aluminum—great savings potential”) by Clean-Lasersysteme, Herzogenrath (North Rhine-Westphalia, DE), cf. <www.cleanlaser.de/de/news/hairpins-aluminium/>, dated Mar. 5, 2021.

In the manufacture of electric motors or electronic generators, in addition to wound stators use is also made nowadays of stators which are formed from metallic, usually bent, bar-shaped conductors (“bar-type conductors”), in particular from what are referred to as hairpins. The bar-type conductors are arranged such that they correspond to an intended electrical connection and are then welded to one another in order to form an electromagnet in this way. By contrast to the wound stator, the hairpin technology enables advantages in terms of weight, costs and efficiency.

The bar-type conductors are frequently welded using a laser beam. To that end, the laser beam is typically directed at the front end faces of two overlapping bar-type conductors that often lie against one another. As a result, heat is introduced into the bar-type conductors, the bar-type conductors melt and, after solidifying, the bar-type conductors are connected to one another by a solidified weld bead.

During the welding, it is necessary to create a sufficiently large cross-sectional area by way of which the electric current can flow between the two bar-type conductors. If the welding is not performed correctly, ohmic heating, a loss of effectiveness or an unusable electrodynamic machine can arise during operation.

Up to now, use has been made mainly of bar-type conductors made of copper. An example for the welding of copper-containing bar-type conductors has been disclosed by the subsequently published German patent application 10 2020 113 179.8.

In the aforementioned online publication, the company Clean-Lasersysteme proposes directly processing hairpins of aluminum instead of copper. To that end, the hairpins of aluminum are welded to one another in a vacuum. The use of the hairpin of aluminum should in particular offer cost advantages. Further details regarding the method are not mentioned.

However, the welding of hairpins of aluminum has proven difficult in practice. The weld beads created by a laser beam can easily run during the welding operation, and therefore often an insufficient cross-sectional area for the conduction of current is obtained, and the welding is unusable.

### SUMMARY

Embodiments of the present invention provide a method for laser welding bar-type conductors. The method includes arranging two bar-type conductors next to one another with a partial overlap, and welding the two bar-type conductors to one another by using a processing laser beam. A weld bead that connects the two bar-type conductors to one another is formed on a common base surface of the bar-type conductors that are next to one another. The common base surface is aligned horizontally. During the welding of the bar-type conductors, the processing laser beam is guided, so that a welding contour of the processing laser beam is placed relative to the bar-type conductors. An advancing rate v of the processing laser beam along the welding contour relative to the bar-type conductors is selected such that, during the welding of the bar-type conductors, the weld bead has a non-liquid oxide skin inside which liquid bar-type conductor material accumulates. The non-liquid oxide skin is partially broken open in a manner corresponding to the welding contour by the processing laser beam only on an upwardly facing end face of the weld bead, and remains undamaged in a surrounding region of the weld bead that extends downward from the upwardly facing end face toward the bar-type conductors and around the entire weld bead.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of two bent bar-type conductors in a partially overlapping arrangement, which are to be welded to one another according to embodiments of the invention;

FIG. 2 shows a schematic oblique view of the end regions, lying against one another, of the two bar-type conductors of FIG. 1 before the start of the laser welding according to embodiments of the invention;

FIG. 3 shows a schematic side view of the two bar-type conductors of FIG. 2 during the laser welding according to embodiments of the invention, together with a weld bead which is forming;

FIG. 4 shows a schematic plan view of the end regions of the two bar-type conductors of FIG. 2 according to embodiments of the invention;

FIG. 5 shows a schematic plan view of the end regions of two bar-type conductors in a variant in which the common base surface is square, according to embodiments of the invention;

FIG. 6a shows a schematic illustration in cross section of a shaped processing laser beam, with core portion and ring portion, according to embodiments of the invention;

FIG. 6b shows a schematic illustration in cross section of an exemplary 2-in-1 fiber, which makes it possible to provide a shaped laser beam for the laser welding, with a core fiber and a ring fiber, according to embodiments of the invention;

FIG. 7 shows a diagram of the core portion of the laser power of a shaped processing laser beam during the laser welding of two bar-type conductors as a function of time, according to embodiments of the invention;

FIG. 8a shows an image from an experiment directly after the end of the laser welding of two aluminum-containing bar-type conductors under conditions in which an oxide skin of a weld bead is repeatedly torn open and a non-uniform weld bead forms, according to embodiments of the invention; and

FIG. 8b shows an image from an experiment directly after the end of the laser welding of two aluminum-containing bar-type conductors under conditions of the method according to embodiments of the invention, in which an oxide skin of a weld bead in a surrounding region remains undamaged and a uniform weld bead forms.

### DETAILED DESCRIPTION

Embodiments of the present invention provide a method for laser welding bar-type conductors of an aluminum-containing alloy, in order to create a usable welded connection with high reliability and in particular to obtain a sufficiently large cross-sectional area for the conduction of current. According to some embb, the bar-type conductors are bent bar-type conductors, in particular hairpins for an electric motor or an electric generator. The bar-type conductors comprise an aluminum-containing bar-type conductor material with an aluminum content of at least 75% by weight, preferably at least 90% by weight. The two bar-type conductors are arranged next to one another with a partial overlap, and are welded to one another by means of a processing laser beam. A weld bead which connects the bar-type conductors to one another is formed on a common base surface of the bar-type conductors that are next to one another, in particular the common base surface being aligned horizontally. According to some embodiments, during the laser welding of the bar-type conductors, the processing laser beam is guided, and in the process a welding contour of the processing laser beam is placed relative to the bar-type conductors and an advancing rate v of the processing laser beam along the welding contour relative to the bar-type conductors is selected, such that,
during the laser welding of the bar-type conductors, the weld bead has a non-liquid oxide skin inside which liquid bar-type conductor material accumulates during the laser welding of the bar-type conductors,
and, during the laser welding of the bar-type conductors, the non-liquid oxide skin being partially broken open in a manner corresponding to the welding contour by the processing laser beam only on an upwardly facing end face of the weld bead,
and, during the laser welding of the bar-type conductors, the non-liquid oxide skin remaining undamaged in a surrounding region of the weld bead that extends downward from the upper end face toward the bar-type conductors and around the entire weld bead.

Embodiments of the invention provide a suitable way of conducting the process of welding two aluminum-containing bar-type conductors to have the effect that a non-liquid oxide layer (“oxide skin”) is formed in the region of the process zone and is kept stable during the welding. Underneath the oxide skin, liquid bar-type conductor material then forms, which is kept in the defined form of a weld bead by the oxide skin. This makes it possible to reliably produce a usable welded connection.

In the case of welding of two metal-containing bar-type conductors, the production of a dimensionally stable weld bead is important since the quality of the weld bead obtained has an effect on the current-conducting properties between the bar-type conductors. Aluminum has considerably lower viscosity and surface tension than copper at the melting temperature. This is why, during welding, the low-viscosity melt of the aluminum-containing alloy tends to run in uncontrolled fashion out of the region of the process zone in which welding is performed. This can lead to a greatly deformed or incompletely formed weld bead and thus a reduced cross-sectional area between the bar-type conductors in which the electric current can flow.

The advantages resulting from the use of aluminum-containing bar-type conductors, like the cost saving already mentioned above but also weight savings (the density of copper in element form, at 8.96 g/cm³, is more than three times the density of aluminum in element form, at 2.7 g/cm³), might then be negated by the disadvantages of a defective or excessively small cross-sectional area between the bar-type conductors.

In the method according to embodiments of the invention, the way of conducting the process is selected such that, during the laser welding of the bar-type conductors, a non-liquid oxide layer (“oxide skin”) is present in the region of the process zone. The oxide skin circumvents the disadvantage of low viscosity and surface tension of the melt of aluminum-containing alloys. The oxide skin keeps the shape of the melt uniform and forms a surrounding region (“lateral surface”) which aligns the melt upward and delimits it to the sides. This produces a uniform weld bead and prevents the melt from running to the sides. The viscosity and surface tension of the melt then no longer matter.

Aluminum stored in air spontaneously forms a thin layer of aluminum oxide (self-passivation), which protects it against corrosion. At the start of the welding method, the bar-type conductor material is thus already covered by an oxide skin, underneath which liquid melt can form and accumulate. During the laser welding, the thickness of the oxide skin can increase compared with the thickness of the oxide skin of the previously solid bar-type conductor, in particular as a consequence of the temperatures reached during laser welding. Furthermore, new aluminum oxide can spontaneously form during the method at locations where molten aluminum is exposed, in particular at locations in the oxide skin that are broken open by the processing laser beam. While the method is being carried out, the oxide skin remains for substantially the entire time to delimit the weld bead which is forming or becoming larger, using the oxide skin present before the start of the laser welding and/or the oxide skin newly formed during the laser welding.

The process is conducted according to embodiments of the invention in such a way that the dynamics of the melt are delimited, in particular close to the surrounding region, and cracks at which melt can exit in uncontrolled fashion, which would result in a non-uniform weld bead, are prevented from forming in the surrounding region. To delimit the dynamics of the melt pool, the processing laser beam may follow the welding contour in particular at a sufficiently low advancing rate. Furthermore, to avoid cracks in the surrounding region of the oxide skin of the weld bead, the welding contour can be selected such that it is sufficiently spaced apart from the periphery of the bar-type conductors (or from the periphery of that side of the bar-type conductors that faces toward the laser beam, the “end face”). The stability of the oxide skin is promoted under these conditions.

In the course of the laser welding of the bar-type conductors, a melt pool is created underneath the oxide skin. This is possible because the melting temperature of aluminum in elementary form, at ≈660° C., is considerably lower than the melting temperature of aluminum oxide, at ≈2070° C. (depending on atmospheric conditions, the processing laser beam can also cause Al₂O₃ to disassociate instead of melting). The melt pool is heated until the desired volume of liquid aluminum is obtained. This ensures that the cross-sectional area between the bar-type conductors upon final solidification is large enough to obtain a sufficiently high conduction of current.

The processing laser beam interacts with the oxide skin substantially only in the region in which the processing laser beam is incident on the oxide skin. The processing laser beam breaks open the oxide skin only along its welding contour, and therefore the welding contour produces a broken-open (i.e. liquid) track, possibly also with a broken-open (or liquid) region inside the welding contour. In all other respects, the oxide skin is maintained and keeps the molten bar-type conductor material together and in shape.

After the processing laser beam has finished acting, the melt pool, which is still kept in shape by the oxide skin, cools down. Upon solidification, the result is then a defined weld bead in the case of which the connected bar-type conductors have a sufficiently large cross-sectional area and ensure a sufficiently good conduction of current. A usable welded connection is reliably produced.

In an embodiment, it is provided that the welding contour of the processing laser beam is placed relative to the bar-type conductors such that, for a smallest distance d of the welding contour from an outer periphery of the common base surface and an extent L of the common base surface along the direction in which the smallest distance d lies, it holds true that:
d≥0.15*L, preferably d≥0.20*L, preferably d≥0.25*L. This involves distances d which have proven successful in practice and with which the probability of damage to the oxide skin is minimized, in particular in the surrounding region.

A variant is preferred in which the welding contour of the processing laser beam is placed relative to the bar-type conductors such that, for a smallest distance d of the welding contour from an outer periphery of the common base surface, it holds true that:
d≥0.6 mm, preferably d≥0.8 mm, preferably d≥1.0 mm. This also involves distances d which have proven successful in practice and with which the probability of damage to the oxide skin is minimized, in particular in the surrounding region.

In an advantageous variant, for the advancing rate v of the processing laser beam along the welding contour of the processing laser beam relative to the bar-type conductors, it holds true that:
v≤1600 mm/s, preferably v≤1200 mm/s, preferably v≤800 mm/s. The advancing rate v has an effect on the dynamics of the melt produced underneath the non-liquid oxide skin. With the advancing rates specified, in practice the oxide skin exhibits good stability and a uniformly shaped weld bead is formed.

A variant in which the laser welding takes place in an oxygen-containing atmosphere, in particular in air, is preferred. The oxygen-containing atmosphere stabilizes the oxide skin of the weld bead and facilitates quick reformation of aluminum oxide on exposed aluminum melt, for instance in the track of the processing laser beam. Moreover, an oxygen-containing atmosphere can be set up easily; in particular when air is used, no additional structures are necessary.

In an embodiment, it is provided that, at least in a chronologically second half of the laser welding of the bar-type conductors, the surrounding region, in which the non-liquid oxide skin remains undamaged, extends over at least ¾ of the height of the weld bead, preferably over at least 9/10 of the height of the weld bead. This ensures the formation of a dimensionally stable and uniform weld bead with a height which sets up an electrical conduction of current, which is sufficient in practice, between the bar-type conductors over the available cross-sectional area of the weld bead. Usually, the surrounding region extends practically over the entire height of the weld bead.

A variant is also preferred in which the two bar-type conductors are arranged with end regions parallel to one another and lying against one another,
in particular with the end regions of the bar-type conductors being extensively pressed against one another,
wherein front end faces of the bar-type conductors are located approximately at the same height in relation to the direction of a longitudinal extent of the end regions of the bar-type conductors,
and wherein the processing laser beam is directed at the front end faces of the bar-type conductors, and therefore the front end faces provide the common base surface on which the weld bead is formed. The arrangement of the end faces at approximately the same height has the effect that a respective melt formed by the processing laser beam at the end faces can combine without problems to form a common, uniformly shaped (spherical) weld bead, and in particular the common weld bead does not have to form a slope. The end regions lying against one another reduces the risk of the melt of the common weld bead flowing out between the bar-type conductors. By pressing the end regions together, a gap remaining between the end regions lying against one another can be minimized.

What is advantageous is a further development of this variant that provides that the end regions of the bar-type conductors are directed approximately vertically upward,
in particular the front end faces being aligned approximately horizontally. In this arrangement, the end faces can be readily accessed by the processing laser beam. The horizontal alignment of the end faces has the effect that the melt that forms does not experience any downhill-slope force and the weld bead can be stable.

Also preferred is a further development in which the processing laser beam is incident on the front end faces approximately perpendicularly. This has the effect of a stable vapor capillary, and the melt pool dynamics are reduced. A defined weld bead can be formed more easily.

What is preferred is a variant that provides that the bar-type conductors, at least close to the common base surface, in particular in a respective end region, each have a rectangular cross section with edge lengths between 0.2 mm and 10 mm, preferably between 1 mm and 8 mm, preferably between 2 mm and 6 mm,
in particular, in the case of a respective bar-type conductor, a long edge length L₂ being twice a short edge length L_{kurz}, and the cross sections of the two bar-type conductors that are welded together being the same. These dimensions have proven successful in practice, in particular for the construction of electric motors. Typically, the long edges of the bar-type conductors lie against one another; this maximizes the cross-sectional area in the weld bead over which the bar-type conductors can be connected to one another. If the long edge is selected to be twice as long as the short edge, a square base surface can be provided with bar-type conductors having the same cross section. The energy from the processing laser beam can be introduced into this base surface uniformly in particular with a circular welding contour.

Further preferred is a variant which provides that a smallest distance d₂ between the welding contour and the outer periphery of the common base surface in the direction of a respective long edge is between 20% and 40%, preferably between 25% and 35%, of the associated long edge length L₂, and a smallest distance d₁ between the welding contour and the outer periphery of the common base surface in the direction of a respective short edge is between 20% and 40%, preferably between 25% and 35%, of twice the short edge length Li. This involves distances d₂ and d₁ which have proven successful in practice and with which the probability of damage to the oxide skin is minimized, in particular in the surrounding region.

In an advantageous variant, the processing laser beam has a laser power P, where

0.5 kW≤P≤20 kW,

preferably 2 kW≤P≤10 kW,

preferably 4 kW≤P≤8 kW,
and/or wherein a wavelength of the processing laser beam is between 400 nm and 1200 nm. These laser powers and wavelengths of the processing laser beam have proven successful in practice for the method according to embodiments of the invention. In particular, it was possible to obtain a uniform formation of the weld beads during the welding process.

Preferred is a variant in which the welding contour is selected to be linear, circular or elliptical and is traversed multiple times during the laser welding of the bar-type conductors,
in particular the welding contour being generated by a scanner optical unit. Traversing the welding contour multiple times during the laser welding of the bar-type conductors makes it possible to uniformly distribute the energy from the processing laser beam, and in the process to introduce virtually any desired amount of energy into the bar-type conductors by virtue of a corresponding number of passes. Local overheating is avoided. Overall, a uniform formation of the weld bead can be achieved. The scanner optical unit, typically formed with a mirror and two piezo-actuators, makes it possible to set up the welding contour on the bar-type conductors or the weld bead with low outlay and to pass through it precisely, in particular also at speeds which it would not be possible to reach or it would be possible to reach only with difficulty by moving the workpiece or laser head mechanically. The shape of the welding contour can be matched to the shape and alignment of the bar-type conductors to be welded.

Further preferred is a variant in which a shaped laser beam having a core portion and a ring portion, which annularly surrounds the core portion, is at least temporarily selected as processing laser beam,
in particular the shaped laser beam being generated by means of a 2-in-1 fiber having a core fiber diameter KFD where 11 μm≤KFD≤300 μm, preferably 50 μm≤KFD≤100 μm, and having a ring fiber diameter RFD where 50 μm≤RFD≤1000 μm, preferably 200 μm≤RFD≤400 μm. The use of the shaped laser beam makes it possible to reduce the melt pool dynamics overall, and welding faults such as spatter formation or pore formation are minimized, in particular at the start and at the end of the method. The power component of the laser power in the core portion may be selected or varied between 20% and 100%, preferably between 20% and 80%, preferably between 40% and 60%. The distribution of the laser power between the core portion and the ring portion can be selected to be constant throughout the welding process if desired, in that case usually with a power component Pₖₑᵣₙ in the core portion of 40-60%. As an alternative, it is also possible to select the power component Pₖₑᵣₙ differently in a first phase (initial phase), a main phase and a last phase (final phase) of the laser welding of the bar-type conductors. If desired, in a main phase of the laser welding (between an initial phase and a final phase), a power component Pₖₑᵣₙ in the core portion of 100% can be selected, in order to increase the process speed, and, in a first phase (initial phase) and/or last phase (final phase), it can be selected to be smaller and in particular continuously variable, in order to minimize welding faults.

In a preferred further development of this variant, a power component Pₖₑᵣₙ of the laser power in the core portion is selected to be smaller during a chronologically first phase of the laser welding of the bar-type conductors than during a main phase of the laser welding of the bar-type conductors,
in particular the power component Pₖₑᵣₙ of the laser power in the core portion increasing continuously during the first phase,
in particular the first phase having a duration between 1 ms and 30 ms. Upon penetration of the processing laser beam (start of the initial phase), the power component Pₖₑᵣₙ selected to be smaller ensures less spatter formation and thus prevents relatively large amounts of liquid melt and non-liquid oxide skin from being flung out of the process zone as early as at the start of the initial phase, which would make it more difficult to form a uniform weld bead. After the penetration, the power component Pₖₑᵣₙ can be increased continuously to a desired power for the main phase. Typically, the first phase (initial phase) comprises a proportion of 10-30% of the overall welding duration. During the first phase, the vapor capillary is formed. The first phase typically lasts at least long as it takes for the vapor capillary to reach at least 30% of its maximum capillary depth during the laser welding of the bar-type conductors.

Similarly preferred is a further development in which a power component Pₖₑᵣₙ of the laser power in the core portion is selected to be smaller during a chronologically last phase of the laser welding of the bar-type conductors than during a main phase of the laser welding of
the bar-type conductors, in particular the power component Pₖₑᵣₙ of the laser power in the core portion decreasing continuously during the last phase,
in particular the last phase having a duration between 1 ms and 30 ms. In the last phase (final phase), the power component Pₖₑᵣₙ selected to be smaller ensures that the vapor capillary can recede in controlled fashion; with a continuously decreasing power component Pₖₑᵣₙ, gentle regression of the vapor capillary can be brought about. This has the effect that no pores, or only a few small pores, are produced within the weld bead. This ensures a reliably usable welded connection. Typically, the last phase (final phase) comprises a proportion of 10-30% of the overall welding duration.

A bar-type conductor arrangement comprising at least two bar-type conductors which have been welded by an above-described method according to embodiments of the invention is also covered within the context of the present invention. The weld bead formed during the welding is uniformly shaped and reliably provides a sufficient cross-sectional area for the flow of electric current between the welded bar-type conductors. Typically, a multiplicity of bar-type conductors are welded consecutively (for example in a stator carrier), with the bar-type conductors being welded at both legs to further bar-type conductors (or, in the case of terminal bar-type conductors, to a power connection).

Furthermore, embodiments of the present invention include the use of bar-type conductor arrangements, the bar-type conductor arrangements each being produced by welding two respective bar-type conductors by an above-described method according to embodiments of the invention, and the bar-type conductor arrangements being installed in an electric motor or an electric generator. The welded connections of the bar-type conductors are reliable and therefore also readily suitable for the high current strengths occurring in electric motors and electric generators. In the case of electric motors provided for mobile applications (for instance electric vehicles), the low inherent weight of bar-type conductors of aluminum-containing bar-type conductor material is advantageous.

Further advantages of embodiments of the invention will emerge from the description and the drawing. Likewise, according to embodiments of the invention, the features mentioned above and those yet to be explained further can be used in each case individually by themselves or together in any desired combination. The embodiments shown and described should not be understood as an exhaustive enumeration, but rather are of an exemplary character.

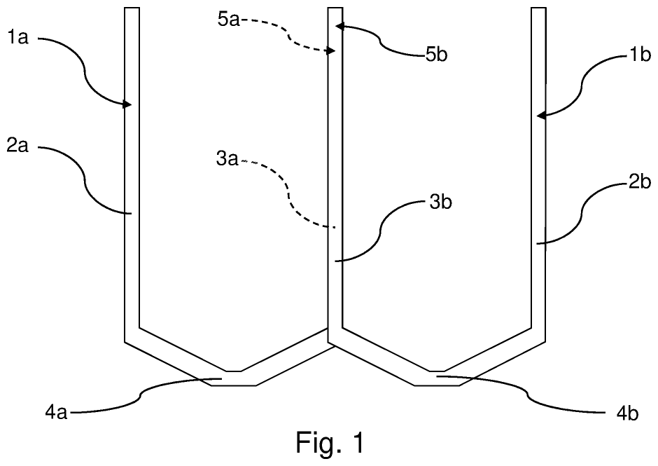

FIG. 1 shows a schematic side view of two aluminum-containing, bent bar-type conductors 1a, 1b. The bar-type conductors 1a, 1b are in the form of what are referred to as hairpins, which are used for the manufacture of an electrodynamic machine, such as an electric motor or an electric generator. The bar-type conductors 1a, 1b are each approximately U-shaped and each have two legs 2a, 3a and 2b, 3b and a middle part 4a, 4b, which connects the respective leg pairs to each other.

The bar-type conductors 1a, 1b are intended to be electrically conductively connected to each other. For this purpose, according to embodiments of the invention, the bar-type conductors 1a, 1b are welded to one another at their end regions 5a, 5b. For the welding, the leg 3a of the first bar-type conductor 1a and the leg 3b of the second bar-type conductor 1b are arranged with an overlap and, in the variant shown here, lying against one another.

For the bar-type conductors 1a, 1b, use is made of aluminum-containing bar-type conductor materials having an aluminum content of at least 75% by weight, preferably at least 90% by weight. Possible aluminum-containing bar-type conductor materials considered are, for example, aluminum alloy groups of series 1000 to 6000 (for example, material EN AW-1050A).

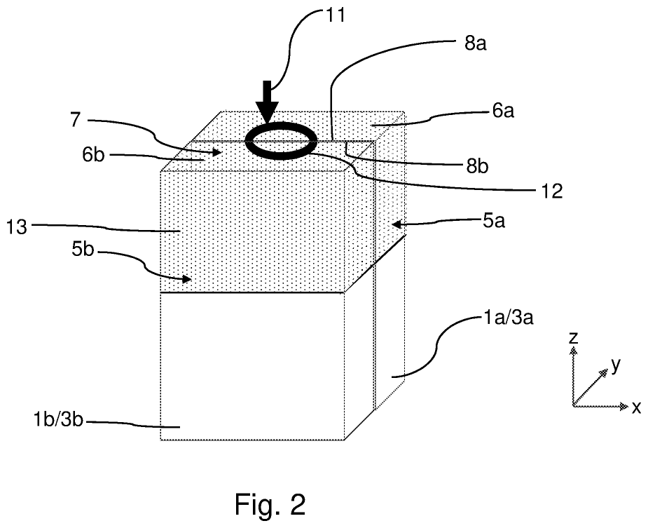

FIG. 2 shows a schematic oblique view of the end regions 5a, 5b of the bar-type conductors 1a, 1b before the start of the laser welding according to embodiments of the invention. The coordinate system is selected such that the x axis points to the right, the y axis points into the plane of the drawing, and the z axis points upward. Here, the front end faces 6a, 6b of the two bar-type conductors 1a, 1b are at approximately the same height and are aligned horizontally. Together, the front end faces 6a, 6b of the two bar-type conductors 1a, 1b form a common base surface 7. The end regions 5a, 5b of the bar-type conductors 1a, 1b each have a rectangular cross section in the xy plane. The long sides 8a, 8b of the cross sections of the bar-type conductors 1a, 1b lie against one another in the end regions 5a, 5b of the legs 3a, 3b, the legs 3a, 3b being pressed against one another (not shown in detail). The legs 3a, 3b are aligned vertically and are parallel to one another, such that the two end faces 6a, 6b and thus the common base surface 7 are aligned upward.

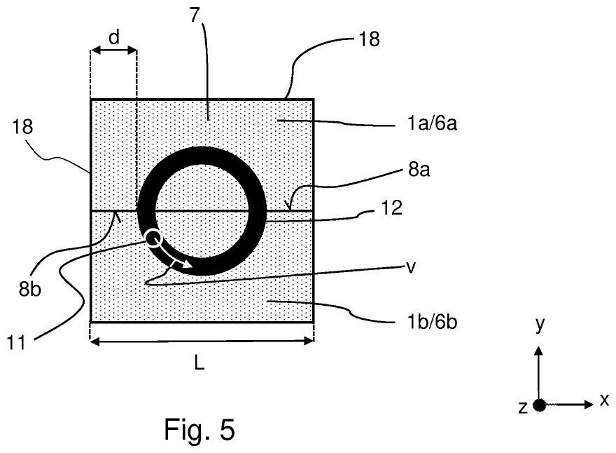

The two end regions 5a, 5b are to be welded using a processing laser beam 11. To that end, a welding contour 12 is defined on the common base surface 7 that then is to be traversed multiple times by the processing laser beam 11. In the embodiment shown here, the welding contour 12 is selected to be elliptical. It is also possible to select linear welding contours (not shown here) or circular welding contours (see FIG. 5) depending on how the bar-type conductors are dimensioned and what the possible requirements for welding are. The dotted region 13 shows that region of the bar-type conductors 1a, 1b that is to be melted by the action of the processing laser beam 11. In an advantageous embodiment, the beam of the processing laser beam 11 can be guided along the welding contour 12 by a scanner optical unit (not shown in detail).

The processing laser beam 11 is incident on the common base surface 7 approximately perpendicularly. It should be noted that, during the manufacture of different pairs of bar-type conductors 1a, 1b, the angle of incidence of the processing laser beam 11 can typically vary slightly in order not to have to move the bar-type conductors 1a, 1b, which are usually arranged in a stator carrier (not shown in detail), too frequently. The processing laser beam 11 typically does not deviate more than 40°, preferably not more than 20°, from a vertical incidence on the base surface 7.

The laser power P of the processing laser beam 11 may be selected such that 0.5 kW≤P≤20 kW, preferably 2 kW≤P≤10 kW, preferably 4 kW≤P≤8 kW, holds true. This makes it possible to achieve good results in practice. For example, a power P of 6 kW can be used to weld two aluminum-containing bar-type conductors 1a, 1b. The wavelength of the processing laser beam 11 may be between 400 nm and 1200 nm. Examples of this are wavelengths of 450 nm (blue), 515 nm (green), 900±100 nm (diode, NIR), 1030 nm (NIR), 1064 nm (NIR) and 1070 nm (NIR).

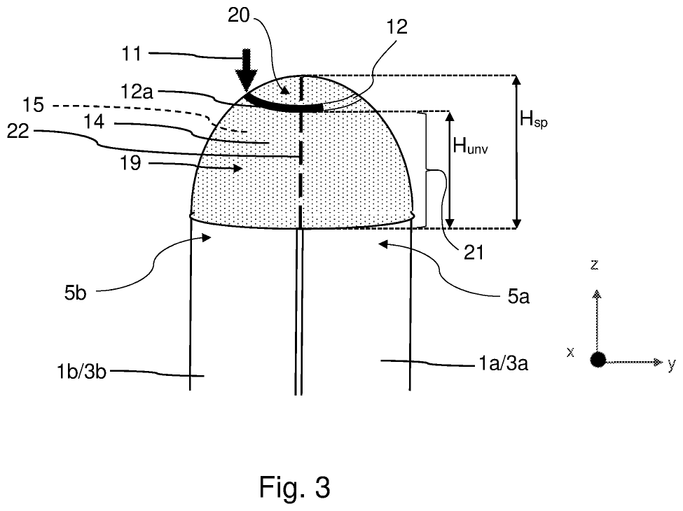

FIG. 3 shows a schematic side view of the two bar-type conductors 1a, 1b of FIG. 2 together with a weld bead 19 in the second half of the laser welding according to embodiments of the invention. The coordinate system is selected such that the x axis points out of the plane of the drawing, the y axis points to the right, and the z axis points upward. What is shown is the end regions 5a, 5b of the bar-type conductors 1a, 1b during the laser welding, a weld bead 19 forming at their ends, in this case the upper ends.

The processing laser beam 11 is intended to move along the welding contour 12, which lies on an upper end face 20 of the weld bead 19. This introduces heat into the aluminum-containing bar-type conductor material. In the process, underneath a non-liquid oxide skin 14 a liquid bar-type conductor material 15 (dashed reference line, since the liquid bar-type conductor material 15 is hidden under the non-liquid oxide skin 14), that is to say an aluminum-containing melt, forms and accumulates. The non-liquid oxide skin 14 then forms the boundary of the weld bead 19 and ensures that the shape of the liquid bar-type conductor material 15 is maintained and the liquid bar-type conductor material 15 is prevented from running. The non-liquid oxide skin 14 is locally broken open by the processing laser beam 11, the processing laser beam 11 leaving behind a broken-open track 12a along the welding contour 12 in the variant shown. This exposes temporarily liquid bar-type conductor material along the track 12a in the broken-open region. Behind the processing laser beam 11, the liquid bar-type conductor material 15 starts to oxidize again, with the result that a new oxide skin 14 forms and the track 12a closes up again. In the variant shown, the track 12a extends over approximately ⅓ of the circumference of the welding contour 12 before the non-liquid oxide skin 14 completely grows back over it. The method according to embodiments of the invention typically takes place in an oxygen-containing atmosphere (for example air), and therefore a non-liquid oxide skin 14 can reform by oxidation quickly in the broken-open region.

The non-liquid oxide skin 14 extends in a surrounding region 21 of the weld bead 19 from the upper end face 20 downward to the still-solid end regions 5a, 5b of the bar-type conductors 1a, 1b and around the entire weld bead 19. In the variant shown here, the non-liquid oxide skin 14 is broken open along the welding contour 12, along which the processing laser beam 11 moves, in the region of the track 12a (shown in black). The exposed liquid bar-type conductor material 15 is reoxidized by the oxygen-containing atmosphere (region of the black contour 12 that is not filled out in FIG. 3). The non-liquid oxide skin 14 of the upper end face 20 remains undamaged in the variant shown here. In other variants, it is also possible for the inner region of the welding contour 12 to be broken open altogether and to remain substantially broken open during the welding process (this possibility is not shown here).

The weld bead 19 has an overall height H sp in the z direction (along the direction of extent of the end regions 5a, 5b of the bar-type conductors 1a, 1b), and the surrounding region 21 of the weld bead 19, in which the non-liquid oxide skin 14 remains undamaged, has a height Hᵤₙᵥ. The height Hᵤₙᵥ generally extends from the lower end of the weld bead 19 to the region in which the processing laser beam 11 moves along the welding contour 12. Since the processing laser beam 11 partially breaks open the non-liquid oxide skin 14 and thus exposes liquid bar-type conductor material 15, that region of the upper end face 20 that is inside the welding contour 12 is no longer considered to be an undamaged part of the surrounding region 21. In the variant shown here, Hᵤₙᵥ extends over approximately ⅘ the height of Hₛₚ. It has been shown to be advantageous that the height Hᵤₙᵥ should extend over at least ¾ the height of Hₛₚ, preferably over at least 9/10 the height of Hₛₚ, in order that a defined weld bead 19 can form. In many use cases, in the case of a weld bead 19 that has a largely flat form at the end face 20, Hᵤₙᵥ extends over practically the entire height Hₛₚ (not shown in detail).

At the end of the welding, after the processing laser beam 11 has finished acting, the liquid bar-type conductor material 15 cools down, continuing to be kept in shape by the non-liquid oxide skin 14, and lastly solidifies. The bar-type conductors 1a, 1b are then electrically conductively connected to one another by the weld bead 19. In the process, the weld bead 19 is placed on both bar-type conductors 1a, 1b and covers them over the entire surface area at their ends. The quality of the electrically conductive connection between the two bar-type conductors 1a, 1b is substantially determined by a connecting cross-sectional area 22. The connecting cross-sectional area 22 is the surface area through which the electrical conduction of current from the first bar-type conductor 1a to the second bar-type conductor 1b is enabled. In the case of the well-defined weld bead 19 shown in FIG. 3, the connecting cross-sectional area 22 corresponds to the cross-sectional area of the weld bead 19 in the plane of contact of the long sides, lying against one another, of the legs 3a, 3b of the bar-type conductors 1a, 1b.

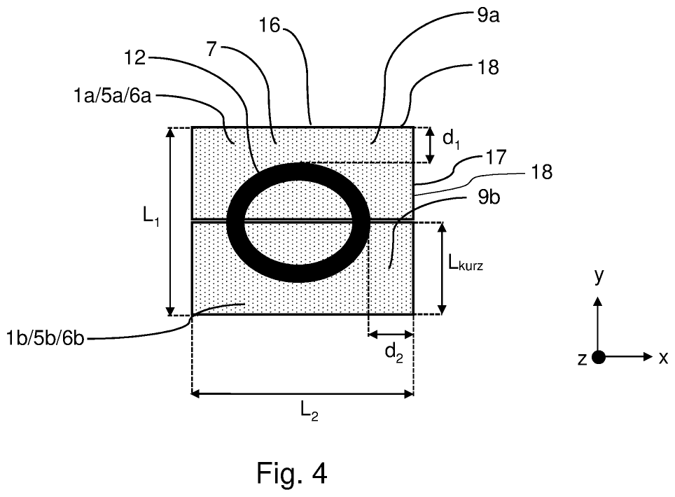

FIG. 4 shows a schematic plan view of the end regions 6a, 6b of the two bar-type conductors 1a, 1b of FIG. 2. The coordinate system is selected such that the x axis points to the right, the y axis points upward, and the z axis points out of the plane of the drawing. The front end faces 6a, 6b form the common base surface 7 on which the elliptical welding contour 12 is shown. The bar-type conductors 1a, 1b each form a respective rectangular cross section 9a, 9b, corresponding to each of the end faces 6a, 6b visible here, in the end regions 5a, 5b. In the present variant, the rectangular cross sections 9a, 9b in the end regions 5a, 5b of the two bar-type conductors 1a, 1b are the same. In practice, the edge lengths of the cross sections 9a, 9b are usually between 0.2 mm and 10 mm, preferably between 1 mm and 8 mm, preferably between 2 mm and 6 mm.

The rectangular front end faces 6a, 6b each have a long edge length L₂ and a short edge length L_{kurz}. The common base surface 7 is described by a long edge length L₂ and twice the short edge length Li. It should be noted that a narrow gap is shown between the front end faces 6a, 6b in FIG. 3 for better clarity. In practice, the bar-type conductors 1a, 1b lie against one another, with the result that the distance is virtually zero and therefore 2*L_{kurz}=L₁.

The smallest distance, which lies between the welding contour 12 and the outer periphery 18 of the common base surface 7 in the direction of (along) a short edge 17, is referred to as a smallest distance d₁. The smallest distance, which lies between the welding contour 12 and the outer periphery 18 of the common base surface 7 in the direction of (along) a long edge 16, is referred to as a smallest distance d₂. In practice, it has been shown that the lateral surface of the non-liquid oxide skin generally remains undamaged during the welding if d₁ is selected to be between 20% and 40% the length of L₁, preferably between 25% and 35% the length of L₁, and d₂ is selected to be between 20% and 40% the length of L₂, preferably between 25% and 35% the length of L₂.

FIG. 5 shows a schematic plan view of the front end faces 6a, 6b of the two bar-type conductors 1a, 1b in a similar way as illustrated in FIG. 4, in a variant in which the common base surface 7 has a square shape. The coordinate system is selected such that the x axis points to the right, the y axis points upward, and the z axis points out of the plane of the drawing. The front end faces 6a, 6b lie coherently against one another at the long edges 8a, 8b. The smallest distance, which lies between the circular welding contour 12 and an outer edge 18 of the common base surface 7, is referred to as a smallest distance d. The common base surface 7 has an extent L along the direction in which the smallest distance d lies. In the variant shown here, it holds true approximately that d=0.25*L. In practice, the smallest distance d between the welding contour 12 and an outer periphery 18 of the common base surface 7 is selected such that d≥15% the length of L, preferably >20% the length of L, preferably ≥25% the length of L. This minimizes the risk of the non-liquid oxide skin tearing open in the surrounding region during the welding. If, for example, a pair of bar-type conductors 1a, 1b with an extent of L=4 mm is selected (this corresponding to a dimensioning which is conventional in practice), the smallest distance d may be ≥0.6 mm, preferably ≥0.8 mm, preferably ≥1 mm.

FIG. 5 also indicates the processing laser beam 11 on the welding contour 12, the laser beam moving along the welding contour 12 at an advancing rate v. In practice, it has been shown that, for the processing laser beam 11, the advancing rate v can advantageously be selected such that v≤1600 mm/s, preferably v≤1200 mm/s, preferably v≤800 mm/s. In the case of an advancing rate v selected in this way (for example 800 mm/s), the dynamics in the liquid bar-type conductor material inside the non-liquid oxide skin are small, and the risk of cracks forming in the surrounding region of the non-liquid oxide skin is low.

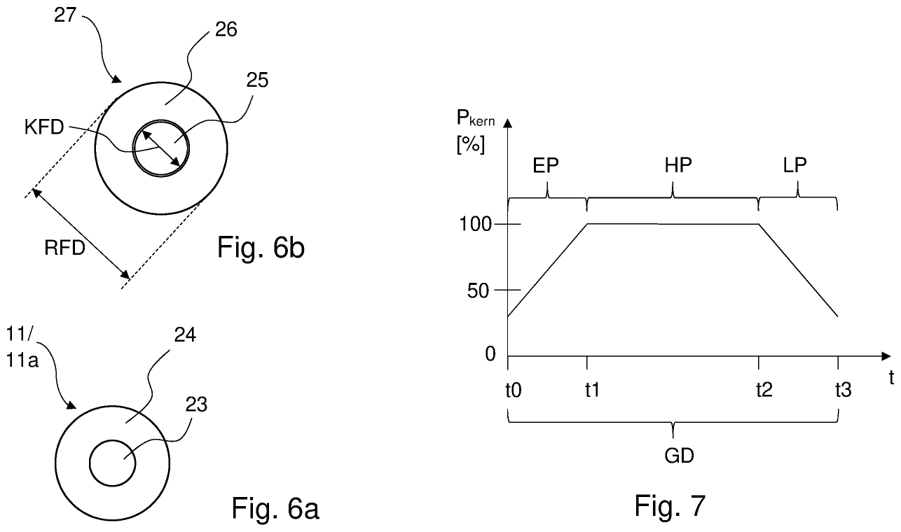

Within the context of the method according to embodiments of the invention, it is advantageous to select the processing laser beam 11 as a shaped laser beam 11a, which at least temporarily has a core portion 23 and a ring portion 24. FIG. 6a shows an example of a beam cross section of such a shaped laser beam 11a. The ring portion 24 surrounds the core portion 23. This allows welding faults to be reduced, in particular at the start of the laser welding and at the end of the laser welding.

The shaped laser beam 11a is produced, for example, by a 2-in-1 fiber 27; FIG. 6b shows a cross section of an exemplary 2-in-1 fiber 27, with which a shaped laser beam for the method according to embodiments of the invention can be provided. The 2-in-1 fiber 27 has a core fiber 25 and a ring fiber 26 that surrounds the core fiber. For the core fiber diameter KFD of such a 2-in-1 fiber 27, it is possible to select, for example, 11 μm≤KFD≤300 μm, preferably 50 μm≤KFD≤100 μm, and, for the ring fiber diameter RFD of such a 2-in-1 fiber 27, it is possible to select, for example, 50 μm≤RFD≤1000 μm, preferably 200 μm≤RFD≤400 μm.

A power component Pₖₑᵣₙ in the core portion and a power component P ring in the ring portion can be set in that an original laser beam is partially fed into the core fiber 25 and partially into the ring fiber 26, for example via an optical wedge (not shown in detail) which is partially pushed into the original laser beam. Within the context of the embodiments of the invention, the power distribution between the core portion and the ring portion can be selected to be constant, or else can be varied, throughout the duration of the laser welding of the bar-type conductors. Typically, Pₖₑᵣₙ is between 20% and 100%, preferably between 20% and 80%, preferably between 40% and 60% of a total laser power P_{ges} of the processing laser beam. Modifying the components of the original laser beam that are fed into the core fiber 25 and the ring fiber 26, for example by shifting the optical wedge (not shown in more detail), makes it possible to vary the power components Pₖₑᵣₙ, P_{ring}. Typically, the total laser power P_{ges}=Pₖₑᵣₙ+P_{ring} is selected to be constant throughout the welding duration.

In an advantageous variant of the laser welding according to embodiments of the invention, which is illustrated in FIG. 7 in the form of a diagram of the power component Pₖₑᵣₙ of the constant total power P_{ges} as a function of time t, the following procedure is adopted:

The laser welding of the two bar-type conductors comprises a first phase (initial phase) EP, a main phase HP and a last phase (final phase) LP, during which movement occurs along the welding contour (for example, an elliptical path or circular path being traversed multiple times). The advancing rate can be selected here typically to be constant throughout the welding duration GD. In the chronologically first phase EP (between the points in time t0 and t1) and in the chronologically last phase LP (between the points in time t2 and t3) of the laser welding of the bar-type conductors, a power component Pₖₑᵣₙ of the laser power in the core is selected to be lower than in the main phase HP in between (between the points in time t1 and t2).

Upon penetration of the shaped laser beam 11a at the start of the chronologically first phase EP (at the point in time t0), the low laser power in the core Pₖₑᵣₙ reduces spatter formation and thus prevents relatively large amounts of non-liquid oxide skin (and liquid melt) from being flung out. The power component in the core Pₖₑᵣₙ starts here at 30% and then increases in the chronologically first phase EP (in this instance linearly) until it has reached a desired value for the main phase HP. For example, the selection of the duration of the first phase EP may depend on whether the vapor capillary produced by the shaped laser beam has reached a certain capillary depth (for example 30% of its maximum capillary depth). The chronologically first phase EP of the laser welding often comprises a component of 10-30% of the total welding duration GD of the welding of the two bar-type conductors and can last, for example, between 1 ms and 30 ms.

In the main phase HP (between the points in time t1 and t2), movement is then performed again along the welding contour 12 with the desired component of the laser power in the core Pₖₑᵣₙ. In the variant shown, Pₖₑᵣₙ is 100% in the main phase, that is to say that the ring component is not illuminated; alternatively, it would also be possible to select Pₖₑᵣₙ to be for example between 60% and 90%.

After the main phase HP (from the point in time t2), the component of the laser power in the core Pₖₑᵣₙ is reduced again (in this case linearly) until it reaches a desired value (in this case in turn 30%). The effect achieved by this is that the vapor capillary produced by the shaped laser beam uniformly recedes, as a result of which only a few pores, if any at all, are obtained in the cooled bar-type conductor material. The chronologically last phase LP of the laser welding often comprises a component of 10-30% of the total welding duration GD of the welding and can last, for example, between 1 ms and 30 ms.

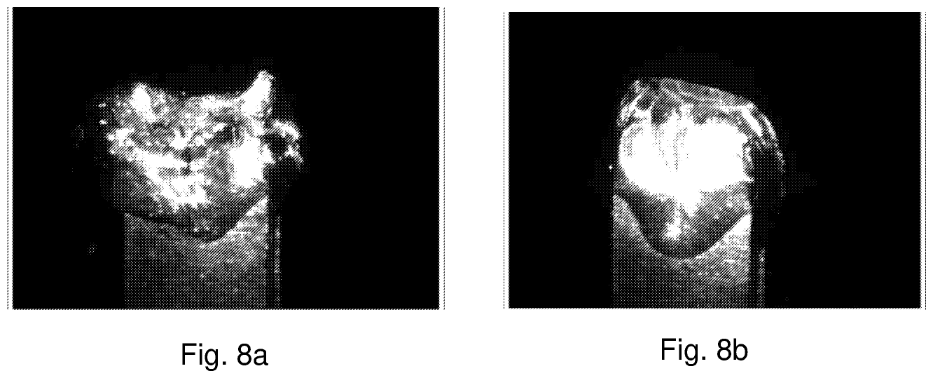

FIG. 8a shows an image, from an experiment, of two aluminum-containing bar-type conductors directly after the end of the laser welding (that is to say before the weld bead solidifies and after the processing laser beam has acted), in which a non-uniform weld bead is formed. In the present example, for the advancing rate v of the processing laser beam v=3200 mm/s was selected and for the laser power P of the processing laser beam P=6 kW was selected; the laser wavelength was 1030 nm, and the total welding time was 85 ms; the bar-type conductors were manufactured from the aluminum alloy EN AW-1050A, and the cross section of the individual hairpins was 2×4 mm, and the welding contour with a circle diameter of 2 mm was in the middle of the end faces, lying against one another, of the hairpins. The high advancing rate v causes high dynamics of the melt. This breaks open the oxide layer at multiple points and destroys its cohesion, and the low-viscosity melt runs in uncontrolled fashion. In this way, it is not possible to obtain a defined weld bead which has an approximately spherical shape. This can be seen in FIG. 8a in the irregularly shaped weld bead and the frayed end face.

By contrast, FIG. 8b shows an image, from an experiment, of two aluminum-containing bar-type conductors directly after the end of the laser welding (before the weld bead solidifies and after the processing laser beam has acted) under conditions of the method according to embodiments of the invention, in which a uniform weld bead is formed. In the present example, for the advancing rate v of the processing laser beam v=800 mm/s was selected and for the laser power P of the processing laser beam P=6 kW was selected; the laser wavelength was 1030 nm, and the total welding time was 85 ms; the bar-type conductors were manufactured from the aluminum alloy EN AW-1050A, and the cross section of the individual hairpins was 2×4 mm, and the welding contour with a circle diameter of 2 mm was in the middle of the end faces, lying against one another, of the hairpins. At the advancing rate v selected here, the non-liquid oxide skin in the surrounding region remains undamaged when processed by the processing laser beam. Lastly, the non-liquid oxide skin is partially broken open in the track of the processing laser beam. In this way, a defined weld bead with an intact non-liquid oxide skin and an approximately spherical shape can be obtained, as can be clearly seen in FIG. 8b.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1a, 1b Bar-type conductor
2a, 2b (Outer) leg
3a, 3b (Inner) leg
4a, 4b Middle part
5b End region
6a, 6b Front end face
7 Common base surface
8a, 8b Long side
9a, 9b Cross section
11 Processing laser beam
11a Shaped laser beam
12 Welding contour
13 Region
14 Non-liquid oxide skin
15 Liquid bar-type conductor material
16 Long edge
17 Short edge
18 Outer periphery
19 Weld bead
20 Front end side
21 Surrounding region
22 Connected cross-sectional area
23 Core portion
24 Ring portion
25 Core fiber
26 Ring fiber
27 2-in-1 fiber
d Smallest distance
d₁ Smallest distance (in the direction of the short edge)
d₂ Smallest distance (in the direction of the long edge)
EP First phase (initial phase)
HP Main phase
Hₛₚ Height of weld bead
Hᵤₙᵥ Height of undamaged surrounding region
KFD Core fiber diameter
LP Last phase (final phase)
L Extent (in the direction of the smallest distance d)
L₁ Twice the short edge length
L₂ Long edge length
L_{kurz} Short edge length
P Laser power
P_{ges} Total laser power
Pₖₑᵣₙ Laser power in the core portion
P_{ring} Laser power in the ring portion
RFD Ring fiber diameter
v Advancing rate

1. A method for laser welding bar-type conductors, the method comprising:
arranging two bar-type conductors next to one another with a partial overlap, and
welding the two bar-type conductors to one another by using a processing laser beam, wherein a weld bead that connects the two bar-type conductors to one another is formed on a common base surface of the bar-type conductors that are next to one another, the common base surface being aligned horizontally,
wherein, during the welding of the bar-type conductors, the processing laser beam is guided so that a welding contour of the processing laser beam is placed relative to the bar-type conductors, and an advancing rate v of the processing laser beam along the welding contour relative to the bar-type conductors is selected such that,
during the welding of the bar-type conductors, the weld bead has a non-liquid oxide skin inside which liquid bar-type conductor material accumulates,
during the welding of the bar-type conductors, the non-liquid oxide skin is partially broken open in a manner corresponding to the welding contour by the processing laser beam only on an upwardly facing end face of the weld bead, and
during the welding of the bar-type conductors, the non-liquid oxide skin remains undamaged in a surrounding region of the weld bead that extends downward from the upwardly facing end face toward the bar-type conductors and around the entire weld bead.

2. The method as claimed in claim 1, wherein
the welding contour of the processing laser beam is placed relative to the bar-type conductors such that, for a smallest distance d of the welding contour from an outer periphery of the common base surface and an extent L of the common base surface along a direction in which the smallest distance d lies, it holds true that:
d≥0.15*L.

3. The method as claimed in claim 1, wherein
the welding contour of the processing laser beam is placed relative to the bar-type conductors such that, for a smallest distance d of the welding contour from an outer periphery of the common base surface, it holds true that:
d≥0.6 mm.

4. The method as claimed in claim 1, wherein, for the advancing rate v of the processing laser beam along the welding contour of the processing laser beam relative to the bar-type conductors, it holds true that:
v≤1600 mm/s.

5. The method as claimed in claim 1, wherein the welding of the bar-type conductors takes place in an oxygen-containing atmosphere.

6. The method as claimed in claim 1, wherein, at least in a chronologically second half of the welding of the bar-type conductors, the surrounding region, in which the non-liquid oxide skin remains undamaged, extends over at least ¾ of a height (Hₛₚ) of the weld bead.

7. The method as claimed in claim 1, wherein the two bar-type conductors are arranged with end regions parallel to one another and lying against one another, with the end regions of the bar-type conductors being extensively pressed against one another,
wherein front end faces of the bar-type conductors are located approximately at a same height in relation to a direction of a longitudinal extent of the end regions of the bar-type conductors, and
wherein the processing laser beam is directed at the front end faces of the bar-type conductors, and thereby the front end faces provide the common base surface on which the weld bead is formed.

8. The method as claimed in claim 7, wherein the end regions of the bar-type conductors are directed approximately vertically upward, and
the front end faces are aligned approximately horizontally.

9. The method as claimed in claim 7, wherein the processing laser beam is incident on the front end faces approximately perpendicularly.

10. The method as claimed in claim 1, wherein
each of the bar-type conductors, at least close to the common base surface in a respective end region, has a rectangular cross section with edge lengths between 0.2 mm and 10 mm,
for each respective bar-type conductor, a long edge length is twice of a short edge length, and the cross sections of the two bar-type conductors that are welded to one another are the same.

11. The method as claimed in claim 10, wherein a smallest distance d2 between the welding contour and an outer periphery of the common base surface in a direction of the respective long edge is between 20% and 40% of the associated long edge length, and a smallest distance d1 between the welding contour and the outer periphery of the common base surface in a direction of the respective short edge is between 20% and 40% of twice the short edge length.

12. The method as claimed in claim 1, wherein
the processing laser beam has a laser power P, where
0.5 kW≤P≤20 kW,
and/or wherein a wavelength of the processing laser beam is between 400 nm and 1200 nm.

13. The method as claimed in claim 1, wherein the welding contour is selected to be linear, circular or elliptical, and is traversed multiple times during the welding of the bar-type conductors, and
the welding contour is generated by a scanner optical unit.

14. The method as claimed in claim 1, wherein the processing laser beam, at least temporarily, has a core portion and a ring portion that annularly surrounds the core portion, and
the laser beam is generated using a 2-in-1 fiber having a core fiber diameter KFD, where 11 μm≤KFD≤300 μm, and having a ring fiber diameter RFD, where 50 μm≤RFD≤1000 μm.

15. The method as claimed in claim 14, wherein a power component Pₖₑᵣₙ of a laser power in the core portion is smaller during a chronologically first phase of the welding of the bar-type conductors than during a main phase of the welding of the bar-type conductors,
wherein the power component Pₖₑᵣₙ of the laser power in the core portion increases continuously during the first phase, and
wherein the first phase has a duration between 1 ms and 30 ms.

16. The method as claimed in claim 14, wherein a power component Pₖₑᵣₙ of a laser power in the core portion is smaller during a chronologically last phase of the welding of the bar-type conductors than during a main phase of the welding of the bar-type conductors,
wherein the power component Pₖₑᵣₙ of the laser power in the core portion decreases continuously during the last phase, and
wherein the last phase has a duration between 1 ms and 30 ms.

17. A bar-type conductor arrangement comprising at least two bar-type conductors which have been welded by the method as claimed in claim 1.

18. The method as claimed in claim 1, wherein the bar-type conductors, after being welded together, are installed in an electric motor or an electric generator.

19. The method as claimed in claim 1, wherein the bar-type conductors comprise an aluminum-containing bar-type conductor material with an aluminum content of at least 75% by weight.
